(19) United States
(12) Patent Application Publication
(10) Pub. No.: US 2024/0118897 A1
(43) Pub. Date: Apr. 11, 2024

(54) Instruction Execution Method and Apparatus for Graph Computation

(71) Applicant: ZHEJIANG LAB, Hangzhou (CN)

(72) Inventors: Hongsheng WANG, Hangzhou (CN); Guang CHEN, Hangzhou (CN); Lingfang ZENG, Hangzhou (CN); Aimin PAN, Hangzhou (CN)

(21) Appl. No.: 18/071,978

(22) Filed: Nov. 30, 2022

Related U.S. Application Data
(63) Continuation of application No. PCT/CN2022/124006, filed on Oct. 9, 2022.

(30) Foreign Application Priority Data
Sep. 27, 2022 (CN) 202211177797.3

(51) Int. Cl. G06F 9/38

(52) U.S. Cl. CPC G06F 9/3838; G06F 9/3885

(57) ABSTRACT

Disclosed are an instruction execution method and apparatus for graph computation. The method includes the following steps: S1: sending operators of each node in a computational graph used for neural network computation to an operator interpreter; S2: building, by the operator interpreter, instructions in operation; S3: defining an instruction dependency relationship; S4: building an instruction dependency relationship graph; S5: building a topological order of parallel instructions; S6: scheduling the parallel instructions to hardware resources; S7: building shortest schedules for the parallel instructions: the shortest time required to execute the parallel instructions under the condition of limited hardware resources; and S8: releasing the completed instructions.

### CROSS REFERENCE TO RELATED APPLICATIONS

The disclosure claims priority to Chinese Patent Application No. 202211177797.3 filed to the State Intellectual Property Office of China on Sep. 27, 2022 and entitled “Instruction Execution Method and Apparatus for Graph Computation”, which is incorporated herein by reference in its entirety.

### TECHNICAL FIELD

The disclosure relates to the technical field of computer systems based on specific computing models, in particular to an instruction execution method and apparatus for graph computation.

### BACKGROUND

With neural network models put into practice in recent years, the technology for neural network compilation becomes more and more important. The existing computational graph compilation technology of neural network models has not yet analyzed the dependency relationship among instructions contained in nodes during the execution of a computational graph from a global perspective, and not derived, based on the dependency relationship, a topological order of the instructions that can be executed in parallel in the global computational graph. This leads to a great deal of memory consumption in compiling the neural network model and brings about slower execution efficiency of the computational graph when run on a computer.

### SUMMARY

By analyzing the dependency relationship among instructions during the execution of a computational graph and building a topological order of parallel instructions, the disclosure provides a method and apparatus for scheduling parallel instructions to hardware resources fastest, and provides a compilation technology for instruction execution methods and apparatuses for graph computation. The objective of the disclosure is to provide an instruction execution method and apparatus for graph computation, which solve the problem of how to analyze the dependency relationship among instructions contained in nodes during the execution of a computational graph from a global perspective, and to derive, based on the dependency relationship, a topological order of the instructions that can be executed in parallel in the global computational graph, so as to schedule the parallel instructions to hardware resources fastest.

The technical solutions adopted by the disclosure are as follows:

An instruction execution method for graph computation includes the following steps:
Step S1: sending operators of each node in a computational graph used for neural network computation to an operator interpreter on a computer;
Step S2: building, by the operator interpreter, instructions in operation;
Step S3: defining an instruction dependency relationship;
Step S4: building an instruction dependency relationship graph;
Step S5: building a topological order of parallel instructions;
Step S6: scheduling the parallel instructions to hardware resources;
Step S7: building shortest schedules for the parallel instructions: the shortest time required to execute the parallel instructions under the condition of limited hardware resources; and
Step S8: releasing the completed instructions.

Further, the instruction dependency relationship in step S3 includes a write-read strong dependency relationship, a read-write weak dependency relationship and a write-write weak dependency relationship.

Further, the write-read strong dependency relationship is: writing a register first and then reading the same register according to instruction operations, where the instruction operation of reading the same register later depends on the instruction operation of writing the register first.

Further, the read-write weak dependency relationship is: reading a register first and then writing the same register according to instruction operations, where the instruction operation of writing the same register later depends on the instruction operation of reading the register first.

Further, the write-write weak dependency relationship is: writing a register first and then writing the same register according to instruction operations, where the instruction operation of writing the same register later depends on the instruction operation of writing the register first.

Further, the specific steps of step S4 are: traversing each node in turn according to the topological structure of the computational graph, and building dependency relationship edges of each node by analyzing the dependency relationship between each node instruction and successor node instructions thereof, to form the instruction dependency relationship graph.

Further, the specific steps of step S5 are: traversing each computing node in turn according to the topological structure of the computational graph, and obtaining parallel executable instructions in each step of the execution flow according to the instruction dependency relationship graph, to obtain the topological order of parallel instructions.

Further, the specific step of step S6 is: scheduling the parallel executable instructions in each step to the corresponding hardware resources according to the topological order of the instruction dependency relationship graph.

The disclosure further provides an instruction execution apparatus for graph computation, including a memory and one or more processors, the memory storing executable codes, and the one or more processors executing the executable codes to implement the instruction execution method for graph computation in any of the foregoing embodiments.

The disclosure further provides a computer-readable storage medium storing a program that, when executed by a processor, implements the instruction execution method for graph computation in any of the foregoing embodiments.

The beneficial effects of the disclosure are as follows: the disclosure analyzes the dependency relationship among instructions contained in nodes during the execution of a computational graph from a global perspective, and derives, based on the dependency relationship, a topological order of the instructions that can be executed in parallel in the global computational graph, so as to provide a method and apparatus for scheduling the parallel instructions to hardware resources fastest. The instruction execution efficiency of graph computation is improved by analyzing and designing parallel computation operations, and a compilation technology for instruction execution methods and apparatuses for graph computation is provided. When developing algorithm models, researchers and engineering users use an optimization model for the instruction execution method and apparatus for graph computation to optimize the compilation efficiency of the computational graph and promote the development of landing applications of a neural network model in the relationship graph.

### BRIEF DESCRIPTION OF FIGURES

FIG. 1 shows a schematic flowchart of an instruction execution method for graph computation according to the disclosure;

FIG. 2 shows an architecture diagram of the instruction execution method for graph computation according to an embodiment;

FIG. 3 shows a computational graph for neural network computation according to an embodiment;

FIG. 4 shows that an operator interpreter builds instructions in operation according to an embodiment;

FIG. 5 shows a dependency relationship between instructions according to an embodiment;

FIG. 6 shows analysis on the instruction dependency relationship according to an embodiment;

FIG. 7 shows parallel executable instructions in the first step according to an embodiment;

FIG. 8 shows a parallel executable instruction in the second step according to an embodiment;

FIG. 9 shows a parallel executable instruction in the third step according to an embodiment;

FIG. 10 shows a parallel executable instruction in the fourth step according to an embodiment;

FIG. 11 shows parallel executable instructions in the fifth step according to an embodiment;

FIG. 12 shows a parallel executable instruction in the sixth step according to an embodiment;

FIG. 13 shows a parallel executable instruction in the seventh step according to an embodiment;

FIG. 14 shows a parallel executable instruction in the eighth step according to an embodiment;

FIG. 15 shows analysis on a parallel execution order of instructions according to an embodiment;

FIG. 16 shows shortest schedules for parallel instructions according to an embodiment; and

FIG. 17 shows a schematic structural diagram of an instruction execution apparatus for graph computation according to the disclosure.

### DETAILED DESCRIPTION

The following description of at least one exemplary embodiment is in fact illustrative only, and is definitely not intended to limit the disclosure and the application or use thereof. All other embodiments obtained by those of ordinary skill in the art based on the embodiments in the disclosure without any creative effort fall within the scope of protection of the disclosure.

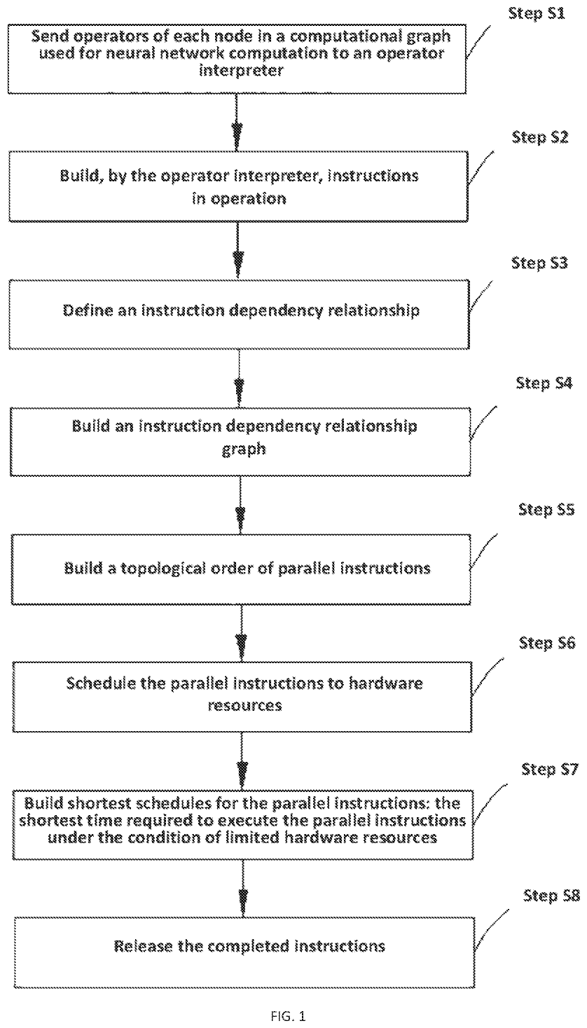

With reference to FIG. 1, an instruction execution method for graph computation includes the following steps:
Step S1: Send operators of each node in a computational graph used for neural network computation to an operator interpreter;
Step S2: Build, by the operator interpreter, instructions in operation;
Step S3: Define an instruction dependency relationship;
   The instruction dependency relationship includes a write-read strong dependency relationship, a read-write weak dependency relationship and a write-write weak dependency relationship; Further, the write-read strong dependency relationship is: writing a register first and then reading the same register according to instruction operations, where the instruction operation of reading the same register later depends on the instruction operation of writing the register first;
   Further, the read-write weak dependency relationship is: reading a register first and then writing the same register according to instruction operations, where the instruction operation of writing the same register later depends on the instruction operation of reading the register first;
   Further, the write-write weak dependency relationship is: writing a register first and then writing the same register according to instruction operations, where the instruction operation of writing the same register later depends on the instruction operation of writing the register first.
Step S4: Build an instruction dependency relationship graph; Each node is traversed in turn according to the topological structure of the computational graph, and dependency relationship edges of each node are built by analyzing the dependency relationship between each node instruction and successor node instructions thereof, to form the instruction dependency relationship graph.
Step S5: Build a topological order of parallel instructions; Each computing node is traversed in turn according to the topological structure of the computational graph, and parallel executable instructions in each step of the execution flow are obtained according to the instruction dependency relationship graph, to obtain the topological order of parallel instructions.
Step S6: Schedule the parallel instructions to hardware resources; The parallel executable instructions in each step are scheduled to the corresponding hardware resources according to the topological order of the instruction dependency relationship graph. The hardware resources include but is not limited to: a variety of general or special CPUs, MPUs, GPUs, DSPs, processors, memory, Cache, etc.
Step S7: Build shortest schedules for the parallel instructions: the shortest time required to execute the parallel instructions under the condition of limited hardware resources.
Step S8: Release the completed instructions.

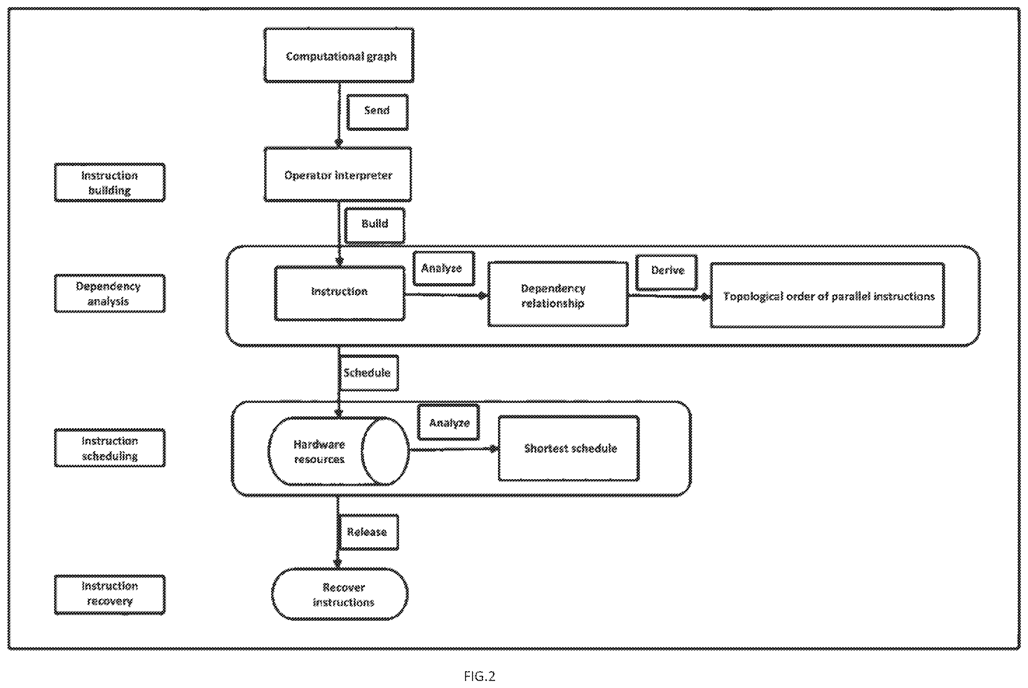

Embodiment: FIG. 2 shows an architecture diagram of an instruction execution method for graph computation.

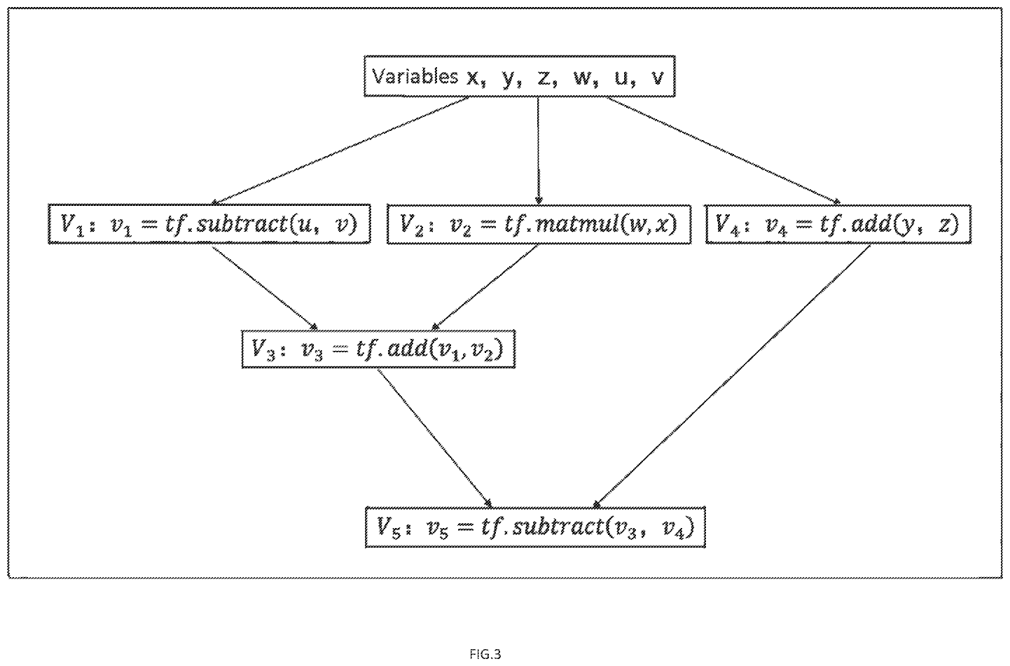

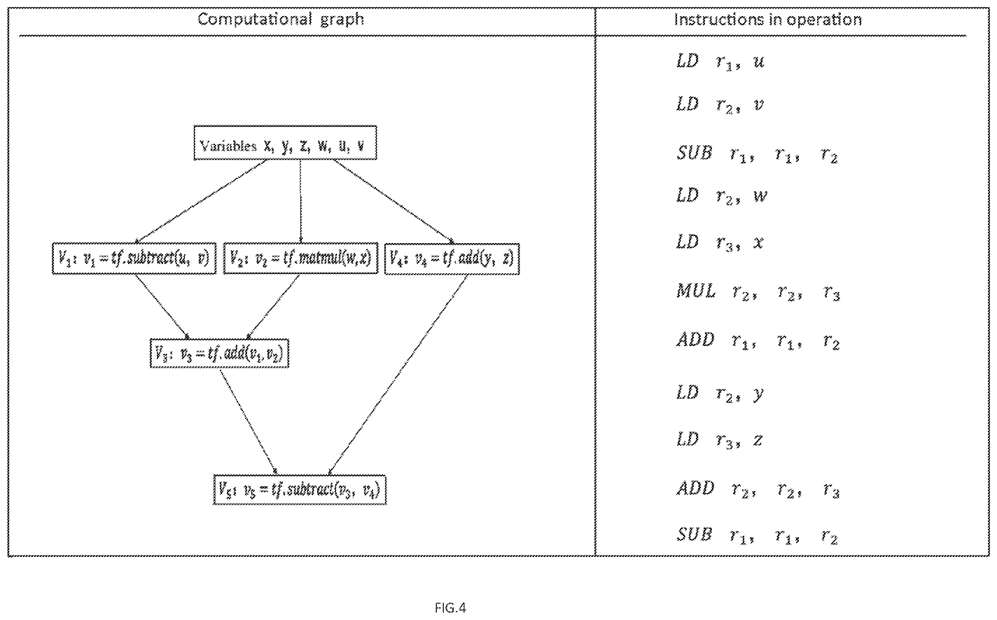

An instruction execution method for graph computation includes the following steps: See FIG. 3. Step S1: Send operators of each node in a computational graph used for neural network computation to an operator interpreter;
tf. matmul(x, y) represents a matrix multiplication operation on a tensor x and a tensor y;
tf. subtract(x, y) represents a matrix subtraction operation on the tensor x and the tensor y;
tf. add(x, y) represents a matrix addition operation on the tensor x and the tensor y.
   See FIG. 4. Step S2: Build, by the operator interpreter, instructions in operation;
LDrᵢ, x: the instruction represents a register write instruction, indicating that the value of a tensor variable x in a memory is written into a register rᵢ;
MULrᵢ, rᵢ, rₖ represents a matrix multiplication operation: read tensor variables in a register rⱼ and a register rₖ respectively, perform the matrix multiplication operation by using the obtained tensor variables, and write the computed result into the register rᵢ;
ADDrᵢ, rⱼ, rₖ represents a matrix addition operation: read the tensor variables in the register rⱼ and the register rₖ respectively, perform the matrix addition operation by using the obtained tensor variables, and write the computed result into the register rᵢ;
SUBrᵢ, rⱼ, rₖ represents a matrix subtraction operation: read the tensor variables in the register rⱼ and the register rₖ respectively, perform the matrix subtraction operation by using the obtained tensor variables, and write the computed result into the register rᵢ.

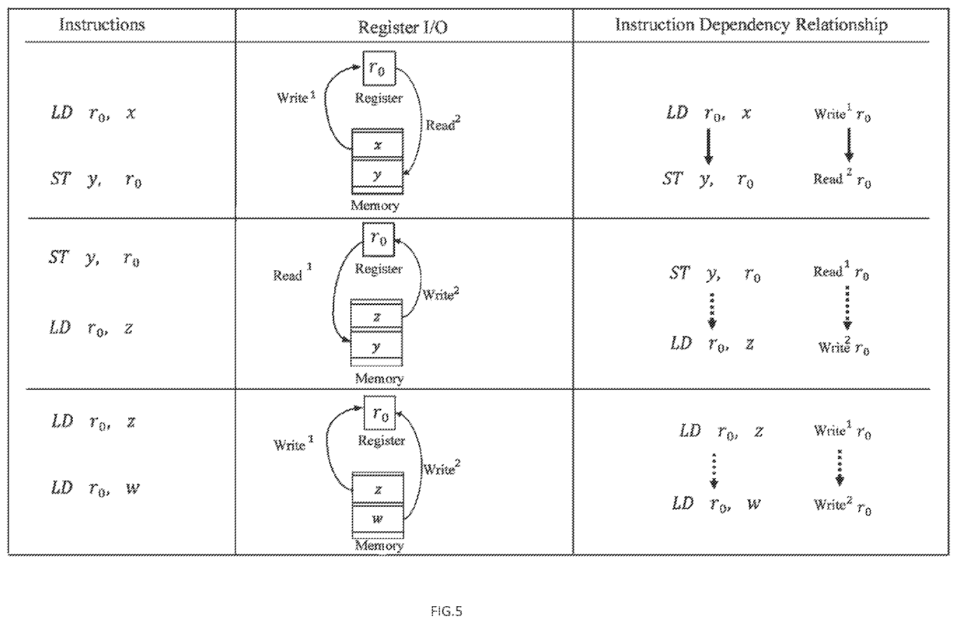

See FIG. 5. Step S3: Define an instruction dependency relationship;
LDrᵢ, x: the instruction represents a register write instruction, indicating that the value of the tensor variable x in the memory is written into the register rᵢ;
STy, r₁: the instruction represents a register read instruction, indicating that the value in the register rᵢ is read and written into the tensor variable y in the memory;
   Write ¹rᵢ represents a register rᵢ write operation for the former;
   Read ¹rᵢ represents a register rᵢ read operation for the former;
   Write ²rᵢ represents a register rᵢ write operation for the latter;
   Read ²rᵢ represents a register rᵢ read operation for the latter.

The instruction dependency relationship includes a write-read strong dependency relationship, a read-write weak dependency relationship and a write-write weak dependency relationship;

Further, the write-read strong dependency relationship is: writing a register first and then reading the same register according to instruction operations, where the instruction operation of reading the same register later depends on the instruction operation of writing the register first;
Further, the read-write weak dependency relationship is: reading a register first and then writing the same register according to instruction operations, where the instruction operation of writing the same register later depends on the instruction operation of reading the register first;
Further, the write-write weak dependency relationship is: writing a register first and then writing the same register according to instruction operations, where the instruction operation of writing the same register later depends on the instruction operation of writing the register first.

Step S4: Build an instruction dependency relationship graph;

Each node is traversed in turn according to the topological structure of the computational graph, and dependency relationship edges of each node are built by analyzing the dependency relationship between each node instruction and successor node instructions thereof, to form the instruction dependency relationship graph;
The analysis on the dependency relationship between each node instruction and successor node instructions thereof refers to the analysis on the dependency relationship between each node instruction and successor node instructions thereof, the dependency relationship including a write-read strong dependency relationship, a read-write weak dependency relationship and a write-write weak dependency relationship.

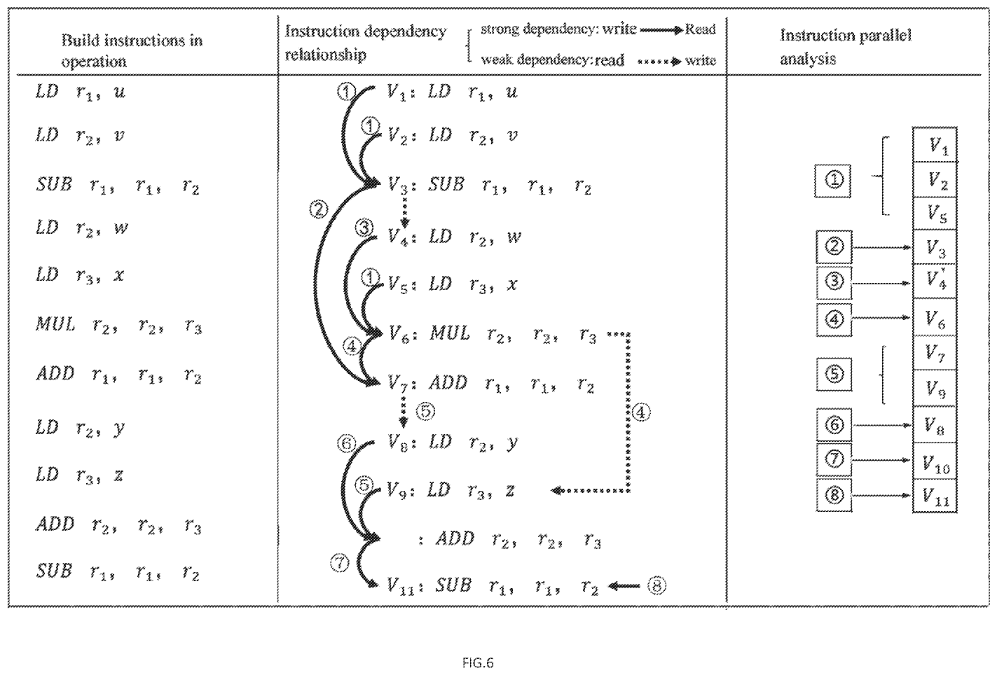

FIG. 6 shows an analysis process of building dependency relationship edges for each node;
Vᵢ→Vⱼ represents that the Vⱼ node is strongly dependent on the Vᵢ node, that is, the Vᵢ node has a write-read dependency relationship with the Vⱼ node.
Vₗ→Vⱼ represents that the Vⱼ node is weakly dependent on the Vᵢ node, that is, the Vᵢ node has a read-write dependency relationship with the Vⱼ node.

$${V}_{i} {\to }^{} {V}_{j}$$

represents that the parallel instructions that can be executed simultaneously in step 1 include the instruction at the Vᵢ node.

Node V₁: node V₁ contains a write register r₁, and node V₃ contains a read register r₁, so node V₁ and node V₃ have a write-read strong dependency relationship between instructions.

Node V₂: node V₂ contains a write register r₂, and node V₃ contains a read register r₂, so node V₂ and node V₃ have a write-read strong dependency relationship between instructions.

Node V₃: 1) node V₃ contains the read register r₂, and node V₄ contains the write register r₂, so node V₃ and node V₄ have a read-write weak dependency relationship between instructions. 2) Node V₃ contains the write register r₁, and node V₇ contains the read register r₁, so node V₃ and node V₇ have a write-read strong dependency relationship between instructions.

Node V₄: node V₄ contains the write register r₂, and node V₆ contains the read register r₂, so node V₄ and node V₆ have a write-read strong dependency relationship between instructions.

Node V₅: node V₅ contains a write register r₃, and node V₆ contains a read register r₃, so node V₅ and node V₆ have a write-read strong dependency relationship between instructions.

Node V₆: 1) node V₆ contains the write register r₂, and node V₇ contains the read register r₂, so node V₆ and node V₇ have a write-read strong dependency relationship between instructions. 2) Node V₆ contains the read register r₃, and node V₉ contains the write register r₃, so node V₆ and node V₉ have a read-write weak dependency relationship between instructions.

Node V₇: node V₇ contains the read register r₂, and node V₈ contains the write register r₂, so node V₇ and node V₈ have a read-write weak dependency relationship between instructions.

Node V₈: node V₈ contains the write register r₂, and node V₁₀ contains the read register r₂, so node V₈ and node V₁₀ have a write-read strong dependency relationship between instructions.

Node V₉: node V₉ contains the write register r₃, and node V₁₀ contains the read register r₃, so node V₉ and node V₁₀ have a write-read strong dependency relationship between instructions.

Node V₁₀: node V₁₀ contains the write register r₂, and node V₁₁ contains the read register r₂, so node V₁₀ and node V₁₁ have a write-read strong dependency relationship between instructions.

Step S5: Build a topological order of parallel instructions;

Each computing node is traversed in turn according to the topological structure of the computational graph, and parallel executable instructions in each step of the execution flow are obtained according to the instruction dependency relationship graph, to obtain the topological order of parallel instructions;
The parallel executable instructions in each step indicates that, when the state of the current instruction to be analyzed is executed during running, if the current instruction to be analyzed has no any dependent precursor node in the instruction dependency relationship graph, the current parallel executable instructions include the current instruction to be analyzed.

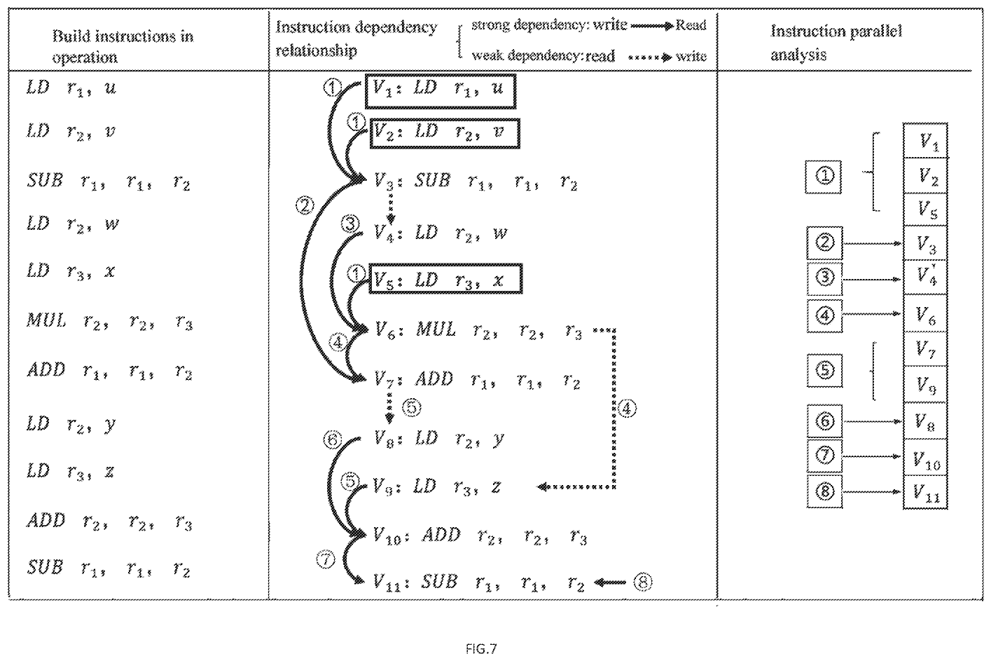

FIG. 7 shows parallel executable instructions in the first step, such as the instructions in the rectangular boxes identified by symbol \textcircled{1} in the figure;

Parallel executable instructions in the first step: the instructions contained in node V₁, node V₂ and node V₅, which have no dependency relationship, can be executed in parallel in the first step.

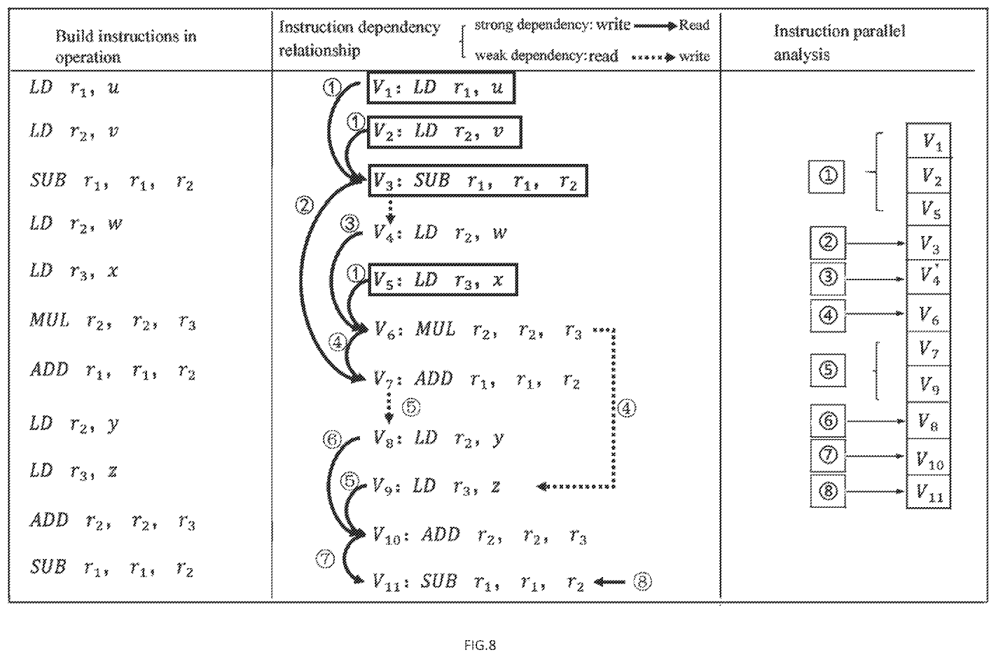

FIG. 8 shows a parallel executable instruction in the second step, such as the instruction in the rectangular box identified by symbol \textcircled{2} in the figure.

Parallel executable instruction in the second step: because node V₃ depends on the instructions contained in node V₁ and node V₂, the instruction contained in node V₃ can be executed in the second step. Node V₆ depends on node V₄ in addition to node V₅, and node V₄ depends on node V₃, so node V₆ and node V₃ have an indirect dependency relationship, and the instruction contained in node V₆ cannot be executed in the second step. It is finally concluded that the instruction contained in node V₃ can be executed in parallel in the second step.

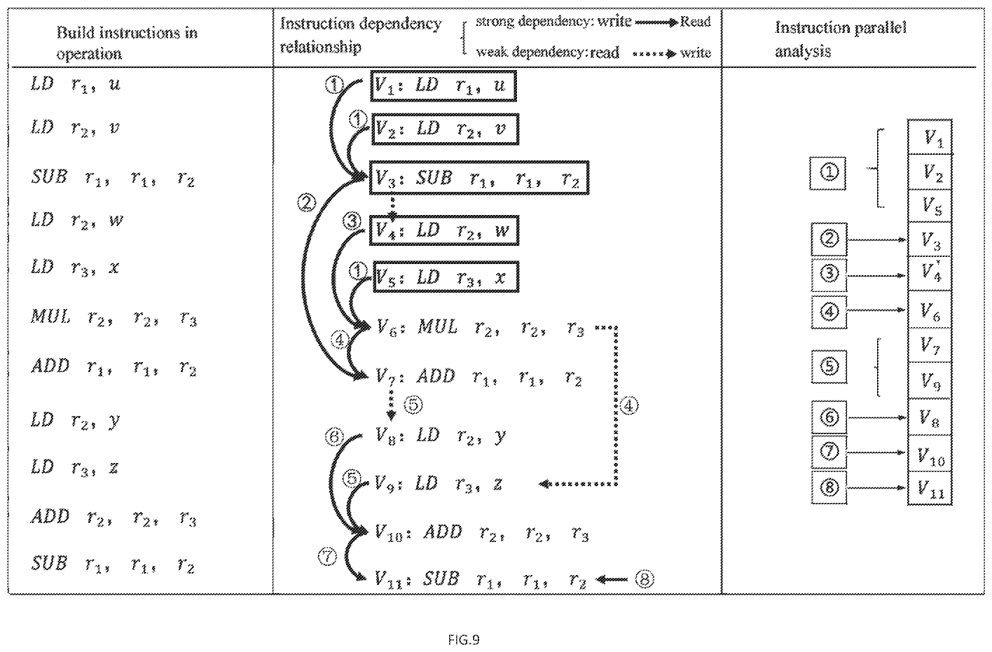

FIG. 9 shows a parallel executable instruction in the third step, such as the instruction in the rectangular box identified by symbol \textcircled{3} in the figure.

Parallel executable instruction in the third step: the nodes directly dependent on node V₃ include V₄ node and V₇ node. In addition, node V₄ depends only on node V₃, so the instruction contained in node V₄ can be executed in the third step. Node V₇ depends on node V₆ in addition to node V₃, and node V₆ depends on node V₄, so node V₇ and node V₄ have an indirect dependency relationship, and the instruction contained in node V₇ cannot be executed in the third step. It is finally concluded that the instruction contained in node V₄ can be executed in parallel in the third step.

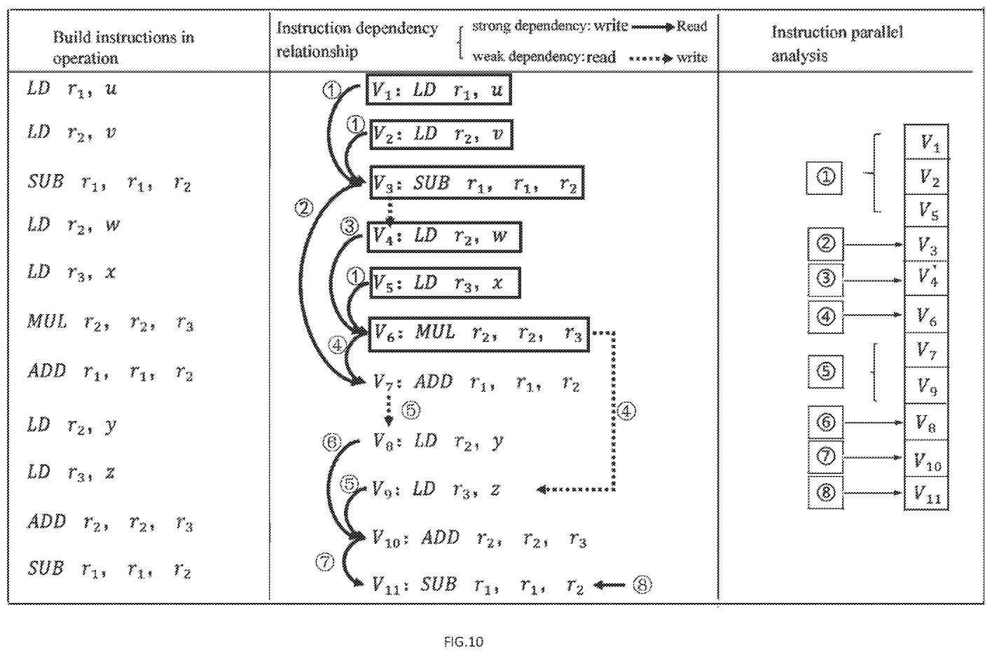

FIG. 10 shows a parallel executable instruction in the fourth step, such as the instruction in the rectangular box identified by symbol \textcircled{4} in the figure.

Parallel executable instruction in the fourth step: the nodes directly dependent on node V₄ include only V₆ node. Although node V₆ depends on node V₅ in addition to node V₄, the instruction contained in node V₅ has been executed in the first step, so it can be regarded as that node V₆ depends only on node V₄ in the fourth step. Therefore, the instruction contained in node V₆ can be executed in the fourth step. It is finally concluded that the instruction contained in node V₆ can be executed in parallel in the fourth step.

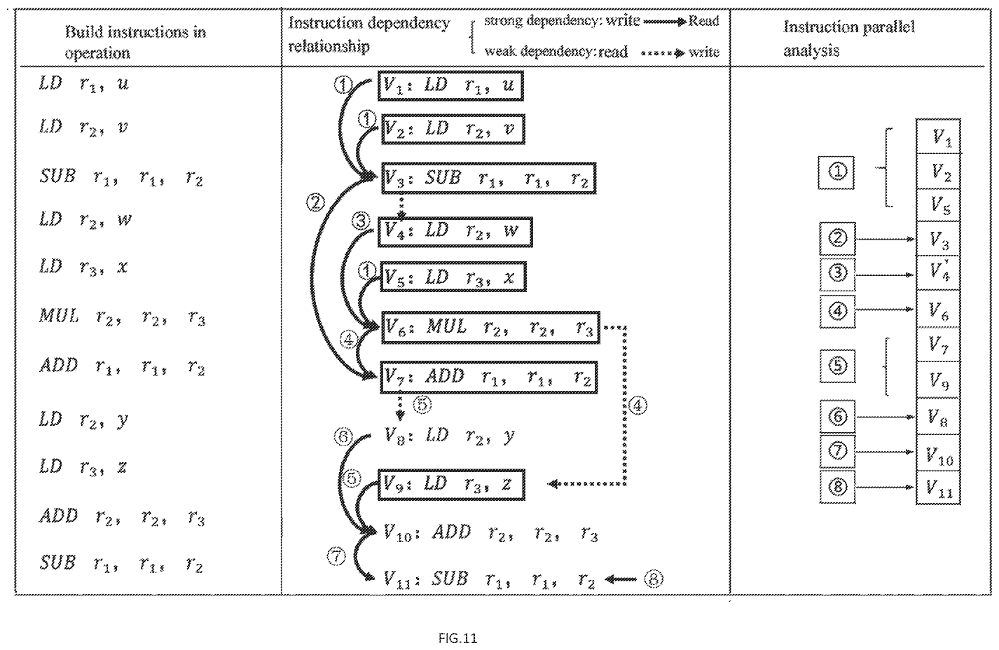

FIG. 11 shows parallel executable instructions in the fifth step, such as the instructions in the rectangular box identified by symbol \textcircled{5} in the figure.

Parallel executable instructions in the fifth step: the nodes directly dependent on node V₆ include V₇ node and V₉ node, and node V₉ depends only on node V₆. It is finally concluded that the instructions contained in node V₇ and V₉ can be executed in parallel in the fifth step.

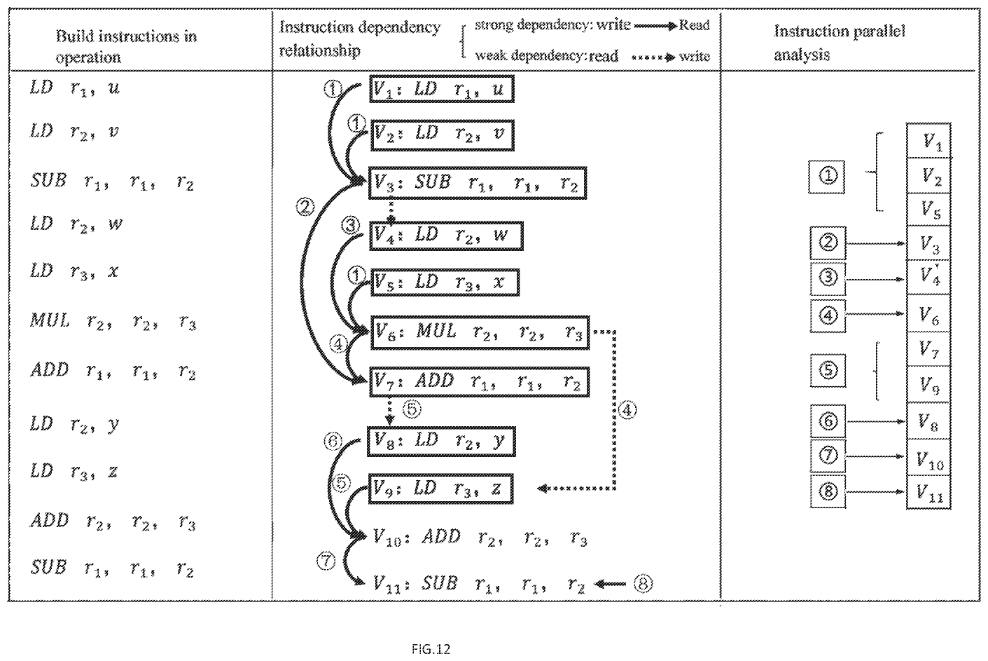

FIG. 12 shows a parallel executable instruction in the sixth step, such as the instruction in the rectangular box identified by symbol \textcircled{6} in the figure.

Parallel executable instruction in the sixth step: the nodes directly dependent on node V₇ include V₈ node, the nodes directly dependent on node V₉ include V₁₀ node, but node V₁₀ depends on node V₈. It is finally concluded that the instruction contained in node V₈ can be executed in parallel in the sixth step.

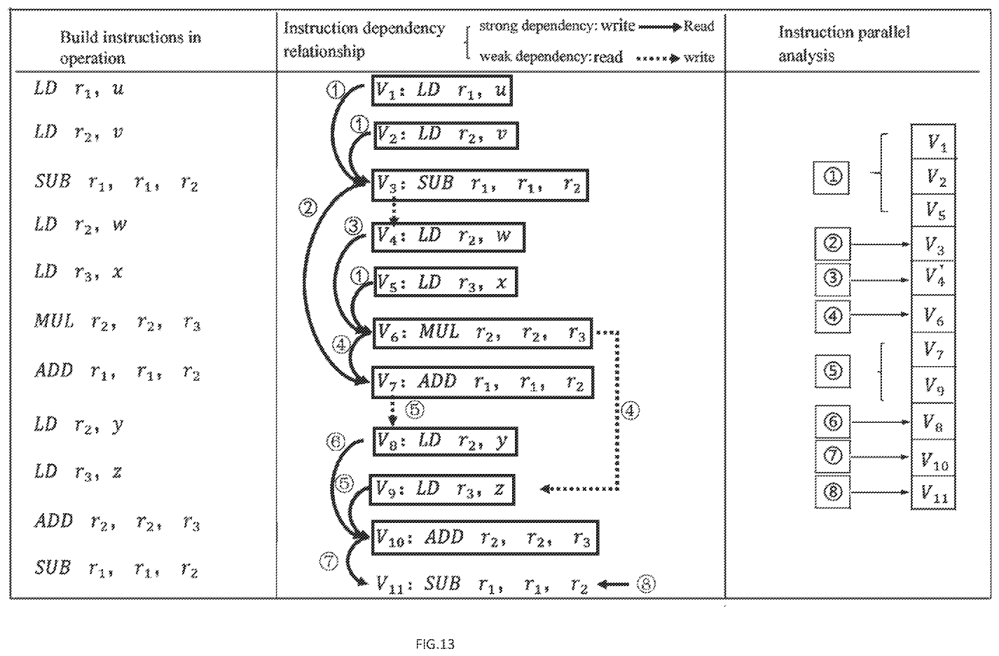

FIG. 13 shows a parallel executable instruction in the seventh step, such as the instruction in the rectangular box identified by symbol \textcircled{7} in the figure.

Parallel executable instruction in the seventh step: the nodes directly dependent on node V₈ include node V₁₀, node V₁₀ also depends on node V₉, but the instruction contained in node V₉ has been executed in the fifth step. It is finally concluded that the instruction contained in node V₁₀ can be executed in parallel in the seventh step.

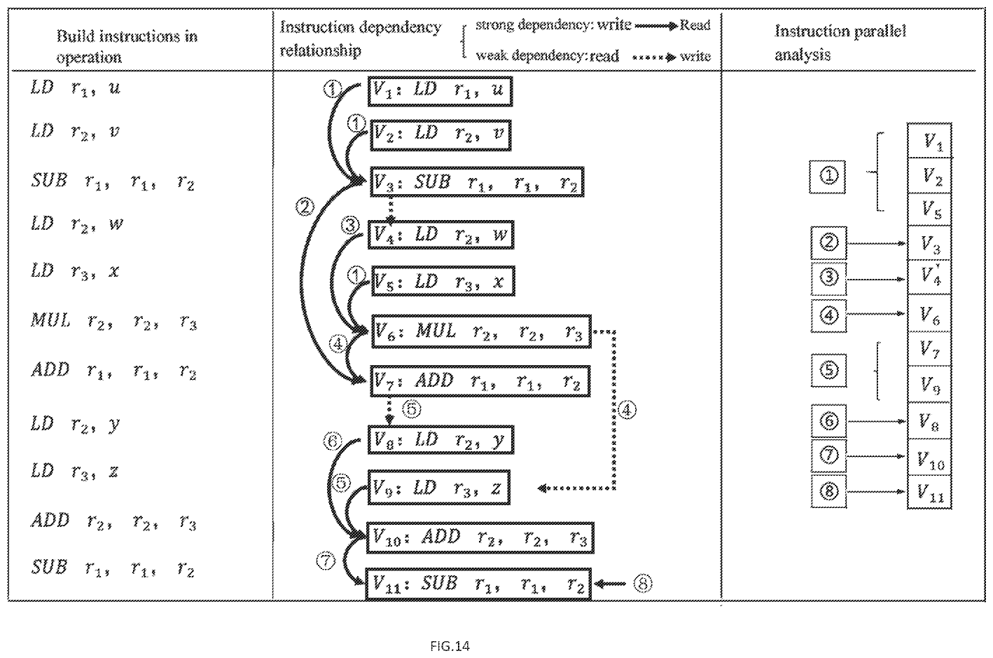

FIG. 14 shows a parallel executable instruction in the eighth step, such as the instruction in the rectangular box identified by symbol \textcircled{8} in the figure.

Parallel executable instruction in the eighth step: the nodes directly dependent on node V₁₀ include only V₁₁ node. It is finally concluded that the instruction contained in node V₁₁ can be executed in parallel in the eighth step.

Step S6: Schedule the parallel instructions to hardware resources;

According to the topological order of the instruction dependency relationship graph, the parallel executable instructions in each step are scheduled to the corresponding hardware resources;
The parallel executable instructions in each step are scheduled to the corresponding hardware resources, where data loading instructions LD and data storage instructions ST about data handling are scheduled to a memory unit, and instructions about arithmetic operations are scheduled to an arithmetic logic unit. The scheduling of instructions to hardware resources indicates that the parallel instructions in each step are scheduled to a position where the corresponding hardware resources can be executed at the earliest. Considering that the resources related to a hardware memory port are always being used by the instruction contained in a precursor node on which the current instruction depends, the position where the hardware resources can be executed at the earliest is the position where the execution of the instruction contained in the precursor node on which the current instruction depends in the topological graph of the instruction dependency relationship ends.

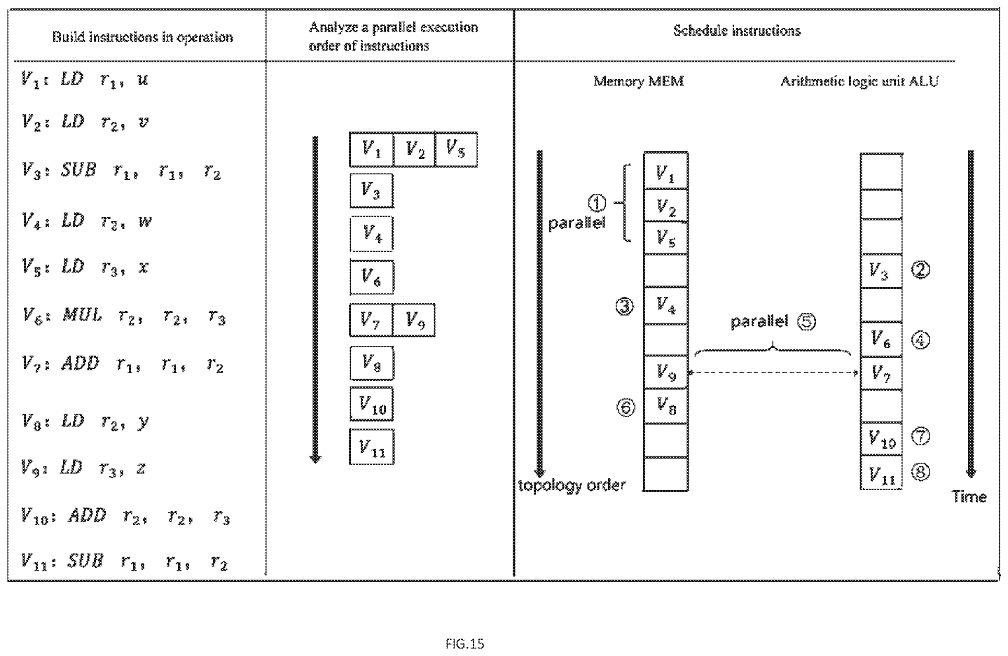

Schedule the parallel instructions in the first step: the scheduling of the parallel instructions in the first step includes the following process: 1) the parallel instructions in the first step include instructions contained in node V₁, node V₂ and node V₅, and the instructions are all data handling instructions, so the instructions contained in node V₁, node V₂ and node V₅ are scheduled to the memory unit. 2) The instructions contained in node V₁, node V₂ and node V₅ are scheduled to a position where the execution begins in the memory unit at the earliest, that is, the initial position of the memory unit, such as the position identified by symbol \textcircled{1} in the arithmetic logic unit in FIG. 15.

Schedule the parallel instruction in the second step: the scheduling of the parallel instruction in the second step includes the following process: 1) the parallel instruction in the second step includes the instruction contained in node V₃, and the instruction is an arithmetic operation instruction, so the instruction contained in node V₃ is scheduled to the arithmetic logic unit. 2) The instruction contained in node V₃ is scheduled to a position where the execution begins in the arithmetic logic unit at the earliest, such as the position identified by symbol \textcircled{2} in the arithmetic logic unit in FIG. 15.

Schedule the parallel instruction in the third step: the scheduling of the parallel instruction in the third step includes the following process: 1) the parallel instruction in the third step includes the instruction contained in node V₄, and the instruction is a data handling instruction, so the instruction contained in node V₄ is scheduled to the memory unit. 2) The instruction contained in node V₄ is scheduled to a position where the execution begins in the memory unit at the earliest, such as the position identified by symbol \textcircled{3} in the arithmetic logic unit in FIG. 15.

Schedule the parallel instruction in the fourth step: the scheduling of the parallel instruction in the fourth step includes the following process: 1) the parallel instruction in the fourth step includes the instruction contained in node V₆, and the instruction is an arithmetic operation instruction, so the instruction contained in node V₆ is scheduled to the arithmetic logic unit. 2) The instruction contained in node V₆ is scheduled to a position where the execution begins in the arithmetic logic unit at the earliest, such as the position identified by symbol \textcircled{4} in the arithmetic logic unit in FIG. 15.

Schedule the parallel instructions in the fifth step: the scheduling of the parallel instructions in the fifth step includes the following process: 1) the parallel instructions in the fifth step include instructions contained in node V₇ and node V₈, the instruction contained in node V₉ is a data handling instruction, and the instruction contained in node V₇ is an arithmetic operation instruction, so the instruction contained in node V₉ is scheduled to the memory unit, and the instruction contained in node V₇ is scheduled to the arithmetic logic unit. 2) The instruction contained in node V₉ is scheduled to a position where the execution begins in the memory unit at the earliest, such as the position identified by symbol \textcircled{5} in the arithmetic logic unit in FIG. 15. The instruction contained in node V₇ is scheduled to a position where the execution begins in the arithmetic logic unit at the earliest, such as the position identified by symbol \textcircled{5} in the arithmetic logic unit in FIG. 15.

Schedule the parallel instruction in the sixth step: the scheduling of the parallel instruction in the sixth step includes the following process: 1) the parallel instruction in the sixth step includes the instruction contained in node V₈, and the instruction is a data handling instruction, so the instruction contained in node V₈ is scheduled to the memory unit. 2) The instruction contained in node V₈ is scheduled to a position where the execution begins in the memory unit at the earliest, such as the position identified by symbol \textcircled{6} in the arithmetic logic unit in FIG. 15.

Schedule the parallel instruction in the seventh step: the scheduling of the parallel instruction in the seventh step includes the following process: 1) the parallel instruction in the seventh step includes the instruction contained in node V₁₀, and the instruction is an arithmetic operation instruction, so the instruction contained in node V₁₀ is scheduled to the arithmetic logic unit. 2) The instruction contained in node V₁₀ is scheduled to a position where the execution begins in the arithmetic logic unit at the earliest, such as the position identified by symbol \textcircled{7} in the arithmetic logic unit in FIG. 15.

Schedule the parallel instruction in the eighth step: the scheduling of the parallel instruction in the eighth step includes the following process: 1) the parallel instruction in the eighth step includes the instruction contained in node V₁₁, and the instruction is an arithmetic operation instruction, so the instruction contained in node V₁₁ is scheduled to the arithmetic logic unit. 2) The instruction contained in node V₁₁ is scheduled to a position where the execution begins in the arithmetic logic unit at the earliest, such as the position identified by symbol \textcircled{8} in the arithmetic logic unit in FIG. 15.

Step S7: Build shortest schedules for the parallel instructions: the shortest time required to execute the parallel instructions under the condition of limited hardware resources;

The building of the shortest schedules for the parallel instructions refers to the shortest time required to execute the parallel instructions under the condition of limited hardware resources. It is assumed that all instruction operations require one clock cycle, with the exception of the data loading instruction LD, which requires two clock cycles. Considering the mechanism that hardware resources cache data to be loaded into a temporary table for the situation of loading first and then storing immediately, and then the data are stored to memory resources from the temporary table when the data storage instructions need to be executed, the data storage instruction ST at the same storage position can be executed at a clock following the start of the data loading instruction LD at this position. In the process of building the shortest schedules for the parallel instructions, because each data handling instruction occupies a hardware memory port during execution, when a plurality of data handling instructions need to be executed in parallel, only one data handling instruction can be executed at a time, and the order of execution can be based on the order principle of priority to the instructions that can be executed at the earliest in the topological graph of the instruction dependency relationship.

The building of the shortest schedules for the parallel instructions includes the following process:

Shortest schedule for the parallel instructions in the first step: the parallel instructions in the first step include data loading instructions LD contained in node V₁, node V₂ and node V₅ among the data handling instructions, and the execution time for each data loading instruction needs two clock cycles, so according to the order principle of instructions that can be executed at the earliest in the topological graph of the instruction dependency relationship, the data loading instructions LD contained in node V₁, node V₂ and node V₅ are sequentially executed, which takes a total of 6 clock cycles.

Shortest schedule for the parallel instruction in the second step: because the parallel instruction in the second step includes an arithmetic operation instruction SUB contained in node V₃, it takes a total of 1 clock cycle to execute the operation.

Shortest schedule for the parallel instruction in the third step: because the parallel instruction in the third step includes a data loading instruction LD contained in node V₃ among the data handling instructions, it takes a total of 2 clock cycles to execute the operation.

Shortest schedule for the parallel instruction in the fourth step: because the parallel instruction in the fourth step includes an arithmetic operation instruction MUL contained in node V₆, it takes a total of 1 clock cycle to execute the operation.

Shortest schedule for the parallel instructions in the fifth step: because the parallel instructions in the fifth step include an arithmetic operation instruction ADD contained in node V₇ and a data loading instruction LD contained in node V₉ among the data handling instructions, the ADD instruction contained in node V₇ and the data loading instruction LD contained in node V₉ can be executed simultaneously, which takes 1 clock cycle to execute the ADD instruction contained in node V₇ and 2 clock cycles to execute the data loading instruction LD contained in node V₉. Therefore, this operation needs a total of 2 clock cycles.

Shortest schedule for the parallel instruction in the sixth step: because the parallel instruction in the sixth step includes a data loading instruction LD contained in node V₈ among the data handling instructions, it takes a total of 2 clock cycles to execute the operation.

Shortest schedule for the parallel instruction in the seventh step: because the parallel instruction in the seventh step includes an arithmetic operation instruction ADD contained in node V₁₀, it takes a total of 1 clock cycle to execute the operation.

Shortest schedule for the parallel instruction in the eighth step: because the parallel instruction in the eighth step includes an arithmetic operation instruction SUB contained in node it takes a total of 1 clock cycle to execute the operation.

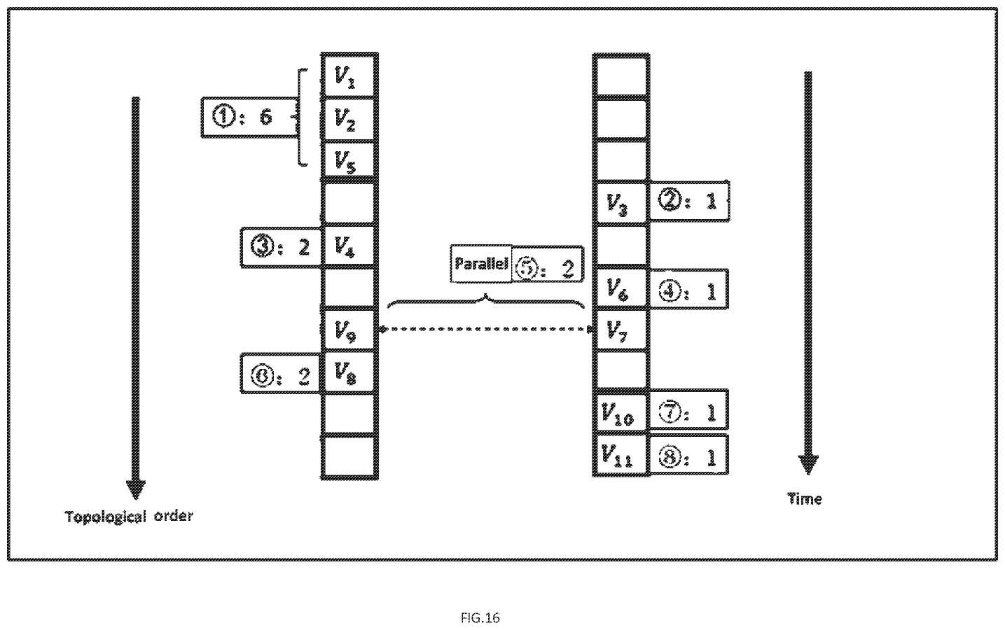

The time required to execute the entire topological graph of the instruction dependency relationship is an accumulation of times required for the shortest schedules for the parallel instructions in the above steps. Therefore, the time required to execute the entire topological graph of the instruction dependency relationship is 6+1+2+1+2+2+1+1, that is, it takes a total of 16 clock cycles to execute the topological graph, as shown in FIG. 16.

Corresponding symbol meanings in FIG. 16 are as follows:

©: a represents that the execution of parallel instructions in step c requires a clock cycles, such as \textcircled{1}: 6 represents that the execution of parallel instructions in the first step requires 6 clock cycles.

Step S8: Release the completed instructions.

The method as stated above analyzes the dependency relationship among instructions contained in nodes during the execution of a computational graph from a global perspective, and derives, based on the dependency relationship, a topological order of the instructions that can be executed in parallel in the global computational graph, so as to provide a method and apparatus for scheduling the parallel instructions to hardware resources fastest. The instruction execution efficiency of graph computation is improved by analyzing and designing parallel computation operations, and a compilation technology for instruction execution methods and apparatuses for graph computation is provided. When developing algorithm models, researchers and engineering users use an optimization model for the instruction execution method and apparatus for graph computation to optimize the compilation efficiency of the computational graph and promote the development of landing applications of a neural network model in the relationship graph.

Corresponding to the foregoing embodiment of the instruction execution method for graph computation, the disclosure further provides an embodiment of an instruction execution apparatus for graph computation.

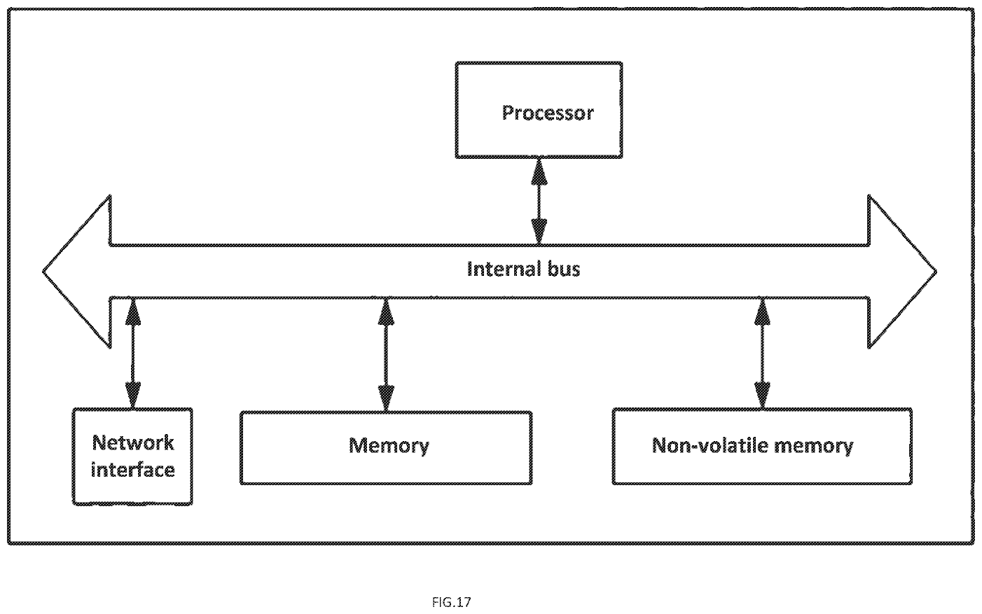

With reference to FIG. 17, the instruction execution apparatus for graph computation, provided by the embodiment of the disclosure, includes a memory and one or more processors, the memory storing executable codes, and the one or more processors executing the executable codes to implement the instruction execution method for graph computation in the foregoing embodiment.

The embodiment of the instruction execution apparatus for graph computation according to the disclosure may be applied to any device having data processing capability, which may be a device or apparatus such as a computer. The embodiment of the apparatus can be implemented by software, hardware, or by a combination of hardware and software. Taking the software implementation as an example, the logical apparatus is formed by reading corresponding computer program instructions in a non-volatile memory into a memory through a processor of any device having data processing capability where the apparatus is located. From the hardware level, as shown in FIG. 17, which is a hardware structure diagram of any device having data processing capability where the instruction execution apparatus for graph computation is located, in addition to the processor, memory, network interface, and non-volatile memory shown in FIG. 17, the any device having data processing capability where the apparatus of the embodiment is located generally may further include other hardware according to the actual functions thereof, and details are not described herein again.

The implementation processes of the functions and effects of the units in the foregoing apparatus are detailed in the implementation processes of the corresponding steps in the foregoing method, and details are not described herein again.

The embodiment of the apparatus substantially corresponds to the embodiment of the method, so relevant parts may refer to the parts of the embodiment of the method. The apparatus examples described above are merely illustrative. The units described as separate components may or may not be physically separated, and the components displayed as units may or may not be physical units, that is, they may be located in one place, or may be distributed to a plurality of network units. Some or all of the modules may be selected according to actual needs to achieve the objectives of the solutions of the disclosure. Those of ordinary skill in the art can understand and implement without any creative effort.

An embodiment of the disclosure further provides a computer-readable storage medium storing a program that, when executed by a processor, implements the instruction execution method for graph computation in the foregoing embodiment.

The computer-readable storage medium may be an internal storage unit of any device having data processing capability descried in any of the foregoing embodiments, such as a hard disk or a memory. The computer-readable storage medium may also be an external storage device of any device having data processing capability, such as a plug-in hard disk, a Smart Media Card (SMC), an SD card, or a flash card equipped on the device. Further, the computer-readable storage medium may further include both an internal storage unit of any device with data processing capability and an external storage device. The computer-readable storage medium is used to store the computer program and other programs and data required by the device with data processing capability, and may also be used to temporarily store data that has been output or will be output.

Described above are only the preferred embodiments of the disclosure, and are not intended to limit the disclosure. The disclosure may have various modifications and variations for those skilled in the art. Any modification, equivalent substitution or improvement made within the spirit and principle of the disclosure shall fall into the protection scope of the disclosure.

What is claimed is:

1. An instruction execution method for graph computation, comprising the following steps:
step S1: sending operators of each node in a computational graph used for neural network computation to an operator interpreter on a computer;
step S2: building, by the operator interpreter, instructions in operation;
step S3: defining an instruction dependency relationship;
step S4: building an instruction dependency relationship graph;
step S5: building a topological order of parallel instructions;
step S6: scheduling the parallel instructions to hardware resources;
step S7: building shortest schedules for the parallel instructions: the shortest time required to execute the parallel instructions under the condition of limited hardware resources; and
step S8: releasing the completed instructions.

2. The instruction execution method for graph computation according to claim 1, wherein the instruction dependency relationship in step S3 comprises a write-read strong dependency relationship, a read-write weak dependency relationship and a write-write weak dependency relationship.

3. The instruction execution method for graph computation according to claim 2, wherein the write-read strong dependency relationship is: writing a register first and then reading the same register according to instruction operations, wherein the instruction operation of reading the same register later depends on the instruction operation of writing the register first.

4. The instruction execution method for graph computation according to claim 2, wherein the read-write weak dependency relationship is: reading a register first and then writing the same register according to instruction operations, wherein the instruction operation of writing the same register later depends on the instruction operation of reading the register first.

5. The instruction execution method for graph computation according to claim 2, wherein the write-write weak dependency relationship is: writing a register first and then writing the same register according to instruction operations, wherein the instruction operation of writing the same register later depends on the instruction operation of writing the register first.

6. The instruction execution method for graph computation according to claim 1, the specific steps of step S4 are: traversing each node in turn according to the topological structure of the computational graph, and building dependency relationship edges of each node by analyzing the dependency relationship between each node instruction and successor node instructions thereof, to form the instruction dependency relationship graph.

7. The instruction execution method for graph computation according to claim 1, wherein the specific steps of step S5 are: traversing each computing node in turn according to the topological structure of the computational graph, and obtaining parallel executable instructions in each step of the execution flow according to the instruction dependency relationship graph, to obtain the topological order of parallel instructions.

8. The instruction execution method for graph computation according to claim 1, wherein the specific step of step S6 is: scheduling the parallel executable instructions in each step to the corresponding hardware resources according to the topological order of the instruction dependency relationship graph.

9. An instruction execution apparatus for graph computation, comprising a memory and one or more processors, the memory storing executable codes, and the one or more processors executing the executable codes to implement the instruction execution method for graph computation according to claim 1.

10. A computer-readable storage medium storing a program that, when executed by a processor, implements the instruction execution method for graph computation according to claim 1.
